(19) United States
(12) Patent Application Publication
(10) Pub. No.: US 2014/0215296 A1
(43) Pub. Date: Jul. 31, 2014

(54) METHOD AND SYSTEM FOR PRESENTING A WEBPAGE

(71) Applicant: CHUNGHWA WIDEBAND BEST NETWORK CO., LTD., New Taipei City (TW)

(72) Inventors: Alan Chen, New Taipei City (TW); Hun-Yeu Lai, New Taipei City (TW)

(21) Appl. No.: 13/750,315

(22) Filed: Jan. 25, 2013

(51) Int. Cl. G06F 17/22

(52) U.S. Cl. CPC G06F 17/2235
USPC 715/205

(57) ABSTRACT

The present invention provides a computer-implemented method of presenting a webpage to a client user, comprising: generating a parent webpage for providing a three-dimensional panoramic display of the scene of a subject area which includes one or more information providing objects and one or more hyperlinks, both of which are integrated as part of the scene of the subject area; and when a specific condition is satisfied for an information providing object while the client user is viewing the parent webpage, the information providing object automatically presenting specific information retrieved from a database.

### FIELD OF THE INVENTION

The present invention relates generally to methods and systems for presenting a webpage.

### BACKGROUND OF THE INVENTION

The design techniques for webpages are continuously advancing and result in the tremendous information contents and the highly diversified services of the internet. However, the current manner of information presentation of the internet is generally through a single webpage with hyperlinks for other webpages. For the purpose of obtaining some kind of information, a user must view the website page-by-page through switching by clicking or touch. The above-described webpage presentation method has at least the following shortcomings:
1. The switch between any two webpages can only be achieved via hyperlinks or previous page/next page links. However, when a user explores and switches between numerous webpages, he/she always gets lost among the webpages due to the complicated link relationships between the webpages and thus is unable to acquire appropriate or desired information.
2. The website is monotonous since there are no interactive relationships between the information providing patterns of different webpages.
3. The information contents of a single webpage is limited by the width of the webpage, and the manner of information providing is also limited.
4. The information providing and contents thereof are passive. A user must find, select, and enter a specific webpage to acquire updated or desired information.

### BRIEF SUMMARY OF THE INVENTION

In one aspect, the present invention provides a computer-implemented method of presenting a webpage to a client user, comprising: generating a parent webpage, wherein the parent webpage provides a three-dimensional panoramic display of the scene of a subject area, and the parent webpage includes one or more information providing objects and one or more hyperlinks for linking to one or more 1^{st} order webpages respectively, both of which are integrated as part of the scene of the subject area; and when a specific condition is satisfied for an information providing object while the client user is viewing the parent webpage, the information providing object automatically presenting specific information retrieved from a database.

In another aspect, the present invention provides a system for presenting a webpage to a client user, comprising: a web server unit configured to, upon execution of computer readable instructions: generate a parent webpage, wherein the parent webpage provides a three-dimensional panoramic display of the scene of a subject area, and the parent webpage includes one or more information providing objects and one or more hyperlinks for linking to one or more 1st order webpages respectively, both of which are integrated as part of the scene of the subject area; when a specific condition is satisfied for an information providing object while the client user is viewing the parent webpage, retrieve specific information from a database and instruct the information providing object to present the same.

The 1^{st} order webpage may be a two-dimensional webpage, or a three-dimensional panoramic webpage. In one embodiment of the present invention, the 1^{st} order webpage is a three-dimensional panoramic webpage and provides a three-dimensional panoramic display of the scene of a local or internal environment of the subject area. The 1^{st} order webpage may include one or more information providing objects and one or more hyperlinks for linking to one or more 2^{nd} order webpages or the parent webpage, both of which are integrated as part of the scene of the local or internal environment of the subject area.

According to the present invention, the specific condition may be selected from the group consisting of a specific time, a specific zooming size of the scene, a specific viewing angel of the scene, a specific searching-keyword, and a combination thereof.

In one preferred embodiment of the present invention, the one or more hyperlinks are generated automatically by determining the relevance between the contents of the parent webpage and the contents of the one or more 1^{st} order webpages.

According to the present invention, the parent webpage may provide a 720-degree view of the scene of the subject area including a 360-degree rotational view in the horizontal direction and a 360-degree rotational view in the vertical direction.

The following improvements can be achieved by the present invention:
1. The one or more hyperlinks are integrated as part of the scene of a subject area, allowing a user to switch between webpages fast and systemically. Furthermore, the one or more hyperlinks can be generated automatically by determining the relevance between the contents of different webpages.
2. The information content capacity of a single webpage is greatly enhanced.
3. Compared to the conventional webpages which only can be switched via previous page/next page links, the three-dimensional (3D) panoramic webpage of the present invention is multi-functional and interactive, and the webpages are integrated and interoperable.
4. The information regarding people, events, times, places and objects can be interlinked through database matching (e.g. keyword matching).
5. The webpage of the present invention has comprehensively interlinked sectors, and can actively present and update information on the information providing object(s), providing diverse and enriched experiences of use. A user can freely surf among different dimensions of the scene without getting lost in the switching between webpages, and can acquire as much as possible updated and desired information in a single webpage.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1A is an architecture diagram of a webpage according to one preferred embodiment of the present invention. FIG. 1B illustrates a parent webpage according to one preferred embodiment of the present invention.

FIG. 2 illustrates a 1^{st} order webpage according to one preferred embodiment of the present invention.

FIG. 3 illustrates switching patterns between webpages of a preferred embodiment of the present invention.

FIG. 4 illustrates switching patterns between webpages of a preferred embodiment of the present invention.

### DETAILED DESCRIPTION OF THE INVENTION

In one aspect, the present invention provides a computer-implemented method of presenting a webpage to a client user, comprising: generating a parent webpage, wherein the parent webpage provides a three-dimensional (3D) panoramic display of the scene of a subject area, and the parent webpage includes one or more information providing objects and one or more hyperlinks for linking to one or more 1^{st} order webpages respectively, both of which are integrated as part of the scene of the subject area; and when a specific condition is satisfied for an information providing object while the client user is viewing the parent webpage, the information providing object automatically presenting specific information retrieved from a database.

According to the present invention, the parent webpage provides a three-dimensional panoramic display (or immersive display) of the scene of a subject area, served as an entry page with enriched information contents. The parent webpage may also provide a 720-degree view of the scene of the subject area (a 720-degree webpage), including a 360-degree rotational view in the horizontal direction and a 360-degree rotational view in the vertical direction. The parent webpage may also be in the form of a 3D map. The parent webpage includes one or more information providing objects and one or more hyperlinks for linking to one or more 1^{st} order webpages respectively, both of which are integrated as part of the scene of the subject area. Take the subject area being a department store as an example, an information providing object may be integrated as a large LED billboard installed in front of the department store, and a hyperlink for link to a 1^{st} order webpage presenting an internal environment of the department store may be integrated as a doorway of the department store.

According to the present invention, the subject area presented in the parent webpage may be in various forms, preferably a city street area or a building.

The information providing object(s) may provide information in various formats, including but not limiting to texts, 2D diagrams, animations, and streaming media.

The 1^{st} order webpage may be a conventional two-dimensional webpage, or a three-dimensional panoramic webpage according to the present invention. According to the present invention, the 1^{st} order webpage may also include one or more information providing objects, and one or more hyperlinks for linking to one or more 2^{nd} order webpages or linking back to the parent webpage.

The 1^{st} order webpage may be a 3D webpage which provides a panoramic display of the scene of another subject area. In one embodiment of the present invention, the 1^{st} order webpage provides a 3D panoramic display of the scene of a local or internal environment of the subject area presented in the parent webpage. The 1^{st} order webpage may include one or more information providing objects and one or more hyperlinks for linking to one or more 2^{nd} order webpages or the parent webpage, both of which are integrated as part of the scene of the local or internal environment.

When a client user is viewing a webpage according to the present invention, he/she is able to surf among different dimensions of the scene by rotating and zooming the 3D panorama of the scene to explore and acquire appropriate or desired information. It is a feature of the present invention to provide active information update and presentation. Thus, when a client user is viewing a webpage, if a specific condition is satisfied for an information providing object, either triggered by the client user or not, the information providing object will automatically present specific information retrieved from a database. The specific condition includes but is not limited to a specific time, a specific zooming size of the scene, a specific viewing angel of the scene, a specific searching-keyword, or a combination thereof.

According to the present invention, the specific information is preferably relevant to the subject area, or the specific condition. Take the subject area being a department store as an example, the information providing object may be in the form of a large LED billboard and when a specific condition is satisfied for the information providing object while a client user is viewing the webpage, the information providing object may present promotion or discount information of the subject department store. The information providing object may be in various forms, including but not limited to a large billboard, a display cabinet for work of art, or a bulletin board. The specific condition to be satisfied may be set according to different forms of information providing object.

Further, the one or more hyperlinks may be generated automatically by determining the relevance between the contents of the parent webpage and the contents of the 1^{st} order webpages, or between the contents of the 1^{st} order webpages and those of the 2^{nd} order webpage, and so on. The contents of the parent webpage and those of the various orders of webpages may be stored in a database. A web server unit may be configured to determine the relevance between the contents and generate a hyperlink between two webpages if they have highly-relevant contents, for example, if a parent webpage is presenting a subject area of a department store and a 1^{st} order webpage is presenting an interior space of the department store.

In another aspect, the present invention provides a system for presenting a webpage to a client user, comprising: a web server unit configured to, upon execution of computer readable instructions: generate a parent webpage, wherein the parent webpage provides a three-dimensional panoramic display of the scene of a subject area, and the parent webpage includes one or more information providing objects and one or more hyperlinks for linking to one or more 1st order webpages respectively, both of which are integrated as part of the scene of the subject area; when a specific condition is satisfied for an information providing object while the client user is viewing the parent webpage, retrieve specific information from a database and instruct the information providing object to present the same.

In one embodiment of the present invention, the web server unit generates the parent webpage based on information from a database. According to the present invention, the parent webpage provides a three-dimensional panoramic display (or immersive display) of the scene of a subject area, served as an entry page with enriched information contents. The parent webpage may also provide a 720-degree view of the scene of the subject area, including a 360-degree rotational view in the horizontal direction and a 360-degree rotational view in the vertical direction. The parent webpage may also be in the form of a 3D map. The parent webpage includes one or more information providing objects and one or more hyperlinks for linking to one or more 1^{st} order webpages respectively, both of which are integrated as part of the scene of the subject area.

The information providing object(s) may provide information in various formats, including but not limiting to texts, 2D diagrams, animations, and streaming media. The subject area presented in the parent webpage may be in various forms, preferably a city street area or a building. The 1^{st} order webpage may be a conventional two-dimensional webpage, or a three-dimensional panoramic webpage according to the present invention. According to the present invention, the 1^{st} order webpage may also include one or more information providing objects, and one or more hyperlinks for linking to one or more 2^{nd} order webpages or linking back to the parent webpage.

The 1^{st} order webpage may be a 3D webpage which provides a panoramic display of the scene of another subject area. In one embodiment of the present invention, the 1^{st} order webpage provides a 3D panoramic display of the scene of a local or internal environment of the subject area presented in the parent webpage. The 1^{st} order webpage may include one or more information providing objects and one or more hyperlinks for linking to one or more 2^{nd} order webpages or the parent webpage, both of which are integrated as part of the scene of the local or internal environment.

While a client user is viewing the webpage, if a specific condition is satisfied for an information providing object, either triggered by the client user or not, the web server unit will retrieve specific information from a database based on the specific condition satisfied. The specific condition includes but is not limited to a specific time, a specific zooming size of the scene, a specific viewing angel of the scene, a specific searching-keyword, or a combination thereof. According to the present invention, the specific information is preferably relevant to the subject area, or the specific condition.

Further, the one or more hyperlinks may be generated automatically by determining the relevance between the contents of the parent webpage and the contents of the 1^{st} order webpages, or between the contents of the 1^{st} order webpages and those of the 2^{nd} order webpage, and so on. The contents of the parent webpage and those of the various orders of webpages may be stored in a database. The web server unit may be configured to determine the relevance between the contents and generate a hyperlink between two webpages if they have highly-relevant contents, for example, if a parent webpage is presenting a subject area of a department store and a 1^{st} order webpage is presenting an interior space of the department store.

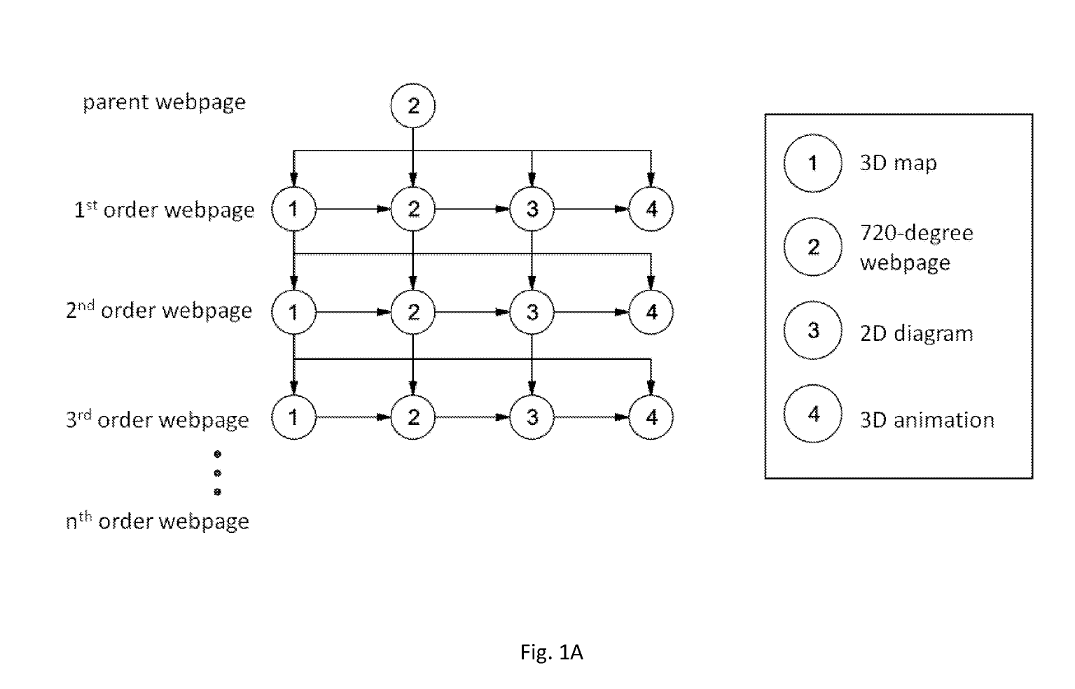

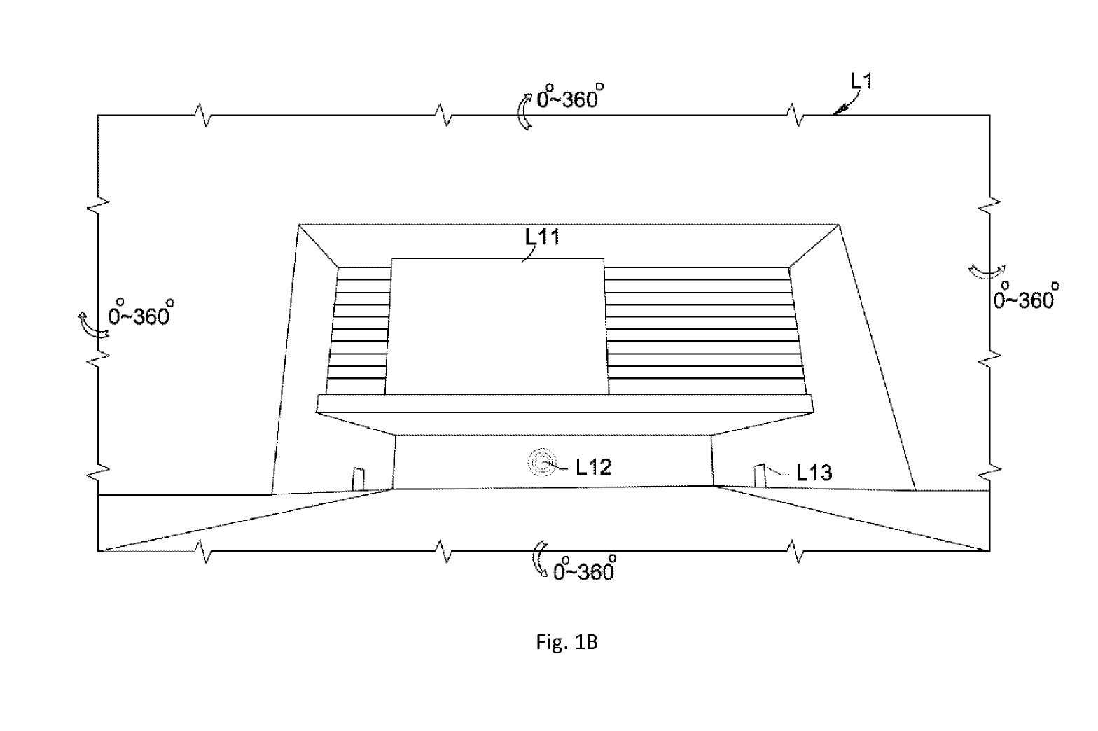

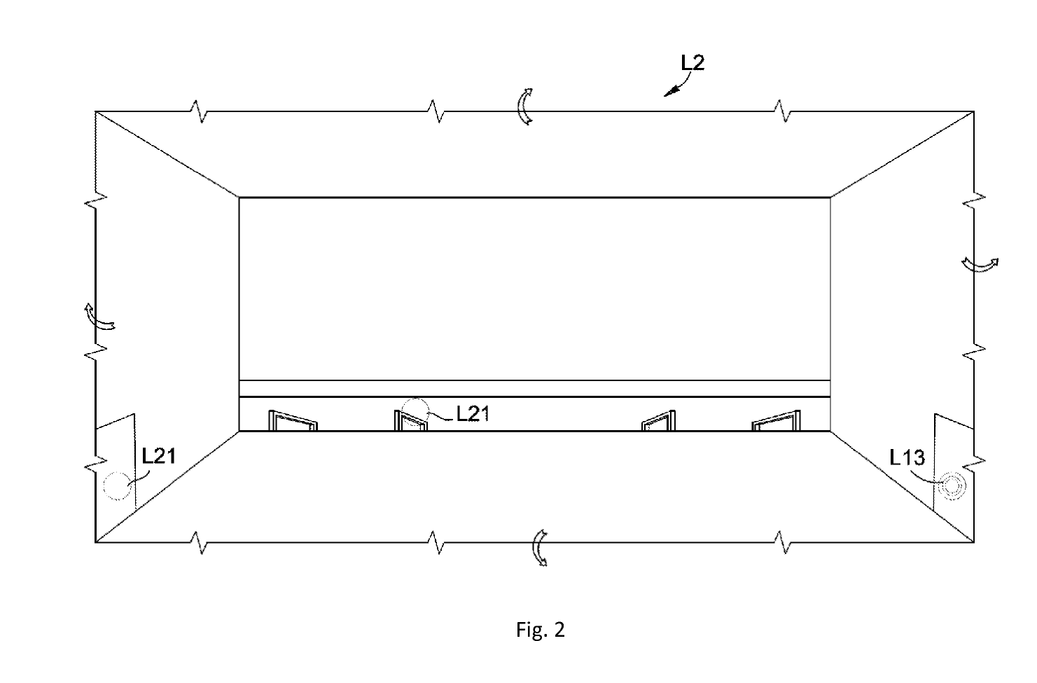

FIG. 1A, FIG. 1B, and FIG. 2 illustrates an embodiment of the present invention. As shown in FIG. 1B, a parent webpage L1 is generated, wherein the parent webpage L1 provides a 3D panoramic display of the scene of a building. The parent webpage L1 includes an information providing object L11 and two hyperlinks L12 and L13. In this example, the information providing object L11 is in the form of a large LED billboard. When a specific condition is satisfied for the information providing object L11 while a client user is viewing the parent webpage, the information providing object L11 automatically presenting specific information retrieved from a database. The hyperlink L13 may be generated automatically by determining the relevance between the contents of the parent webpage L1 and the contents of a 1^{st} order webpage L2 (as shown in FIG. 2). When the client user selects the hyperlink L13, the 1^{st} order webpage L2 will be presented. The 1^{st} order webpage L2 provides a 3D panoramic display of an indoor space of the building. The 1^{st} order webpage L2 includes several information providing objects L21 and a hyperlink L13. As shown in FIG. 1A, a client user may have a diverse and enriched experience of use by freely switching between different forms of webpages, e.g. a 3D map, a 720-degree webpage, a 2D diagram, and a 3D animation.

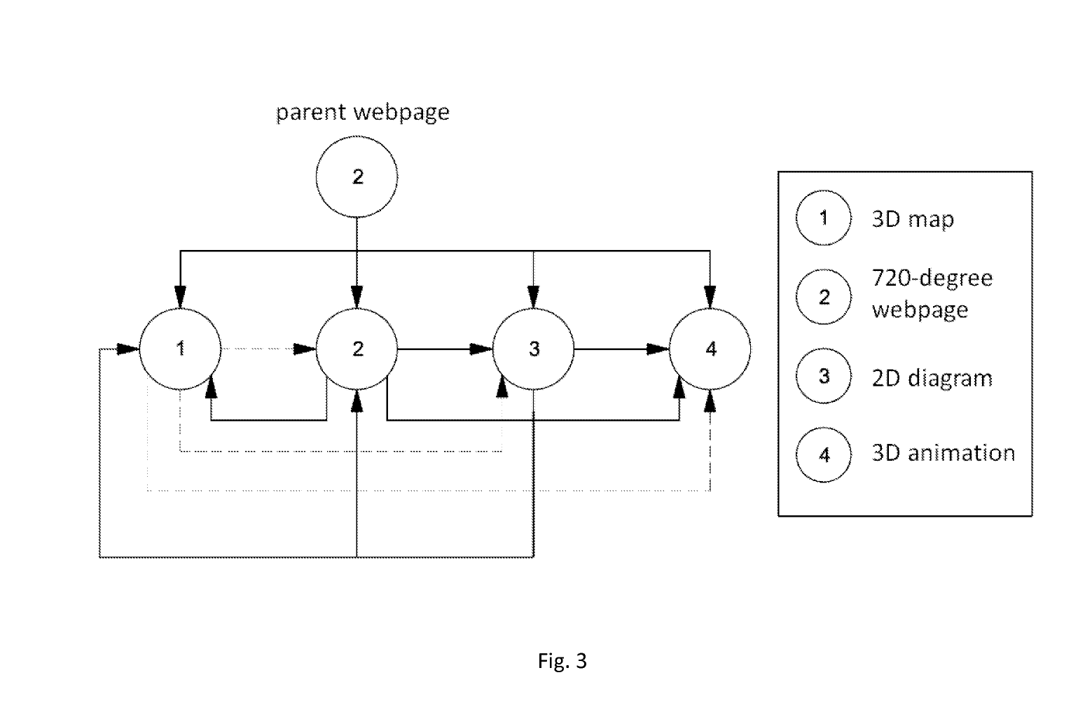

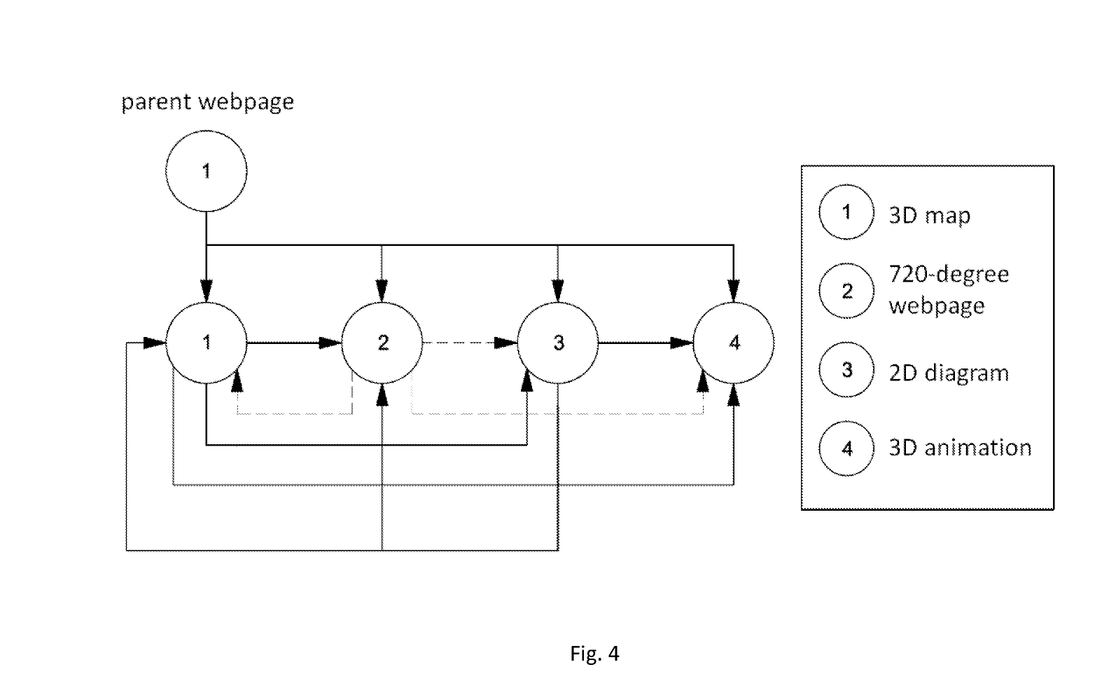

FIG. 3 and FIG. 4 show switching patterns between webpages according to preferred embodiments of the present invention. The parent webpage L1 may be in the form of a 720-degree webpage (FIG. 3; marked as \textcircled{2}) or a 3D map (FIG. 4; marked as \textcircled{1}). A client user may enter a 1^{st} order webpage via the hyperlinks L12 or L13. The 1^{st} order webpage may be in the form of a 2D diagram (marked as \textcircled{3}) or a 3D animation (marked as \textcircled{4}).

In view of the above descriptions, those skilled in the art will recognize that the following improvements can be achieved by the present invention:
1. The one or more hyperlinks are integrated as part of the scene of a subject area, allowing a user to switch between webpages fast and systemically. Furthermore, the one or more hyperlinks can be generated automatically by determining the relevance between the contents of different webpages.
2. The information content capacity of a single webpage is greatly enhanced.
3. Compared to the conventional webpages which only can be switched via previous page/next page links, the three-dimensional (3D) panoramic webpage of the present invention is multi-functional and interactive, and the webpages are integrated and interoperable.
4. The information regarding people, events, times, places and objects can be interlinked through database matching (e.g. keyword matching).
5. The webpage of the present invention has comprehensively interlinked sectors, and can actively present and update information on the information providing object(s), providing diverse and enriched experiences of use. A user can freely surf among different dimensions of the scene without getting lost in the switching between webpages, and can acquire as much as possible updated and desired information in a single webpage.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A computer-implemented method of presenting a webpage to a client user, comprising: generating a parent webpage, wherein the parent webpage provides a three-dimensional panoramic display of the scene of a subject area, and the parent webpage includes one or more information providing objects and one or more hyperlinks for linking to one or more 1^{st} order webpages respectively, both of which are integrated as part of the scene of the subject area; and when a specific condition is satisfied for an information providing object while the client user is viewing the parent webpage, the information providing object automatically presenting specific information retrieved from a database.

2. The method of claim 1, wherein the 1^{st} order webpage is a two-dimensional webpage, or a three-dimensional panoramic webpage.

3. The method of claim 1, wherein the 1^{st} order webpage includes one or more information providing objects and one or more hyperlinks for linking to one or more 2^{nd} order webpages or the parent webpage.

4. The method of claim 1, wherein the 1^{st} order webpage is a three-dimensional panoramic webpage and provides a three-dimensional panoramic display of the scene of a local or internal environment of the subject area.

5. The method of claim 4, wherein the 1^{st} order webpage includes one or more information providing objects and one or more hyperlinks for linking to one or more 2^{nd} order webpages or the parent webpage, both of which are integrated as part of the scene of the local or internal environment of the subject area.

6. The method of claim 1, wherein the subject area is a city street area or a building.

7. The method of claim 1, wherein the specific condition is selected from the group consisting of a specific time, a specific zooming size of the scene, a specific viewing angel of the scene, a specific searching-keyword, and a combination thereof.

8. The method of claim 1, wherein the specific information is relevant to the subject area, or the specific condition.

9. The method of claim 1, wherein the one or more hyperlinks are generated automatically by determining the relevance between the contents of the parent webpage and the contents of the one or more 1^{st} order webpages.

10. The method of claim 1, wherein the parent webpage provides a 720-degree view of the scene of the subject area including a 360-degree rotational view in the horizontal direction and a 360-degree rotational view in the vertical direction.

11. A system for presenting a webpage to a client user, comprising: a web server unit configured to, upon execution of computer readable instructions: generate a parent webpage, wherein the parent webpage provides a three-dimensional panoramic display of the scene of a subject area, and the parent webpage includes one or more information providing objects and one or more hyperlinks for linking to one or more 1^{st} order webpages respectively, both of which are integrated as part of the scene of the subject area; when a specific condition is satisfied for an information providing object while the client user is viewing the parent webpage, retrieve specific information from a database and instruct the information providing object to present the same.

12. The system of claim 11, wherein the 1^{st} order webpage is a two-dimensional webpage, or a three-dimensional panoramic webpage.

13. The system of claim 11, wherein the 1^{st} order webpage includes one or more information providing objects and one or more hyperlinks for linking to one or more 2^{nd} order webpages or the parent webpage.

14. The system of claim 11, wherein the 1^{st} order webpage is a three-dimensional panoramic webpage and provides a three-dimensional panoramic display of the scene of a local or internal environment of the subject area.

15. The system of claim 14, wherein the 1^{st} order webpage includes one or more information providing objects and one or more hyperlinks for linking to one or more 2^{nd} order webpages or the parent webpage, both of which are integrated as part of the scene of the local or internal environment of the subject area.

16. The system of claim 11, wherein the subject area is a city street area or a building.

17. The system of claim 11, wherein the specific condition is selected from the group consisting of a specific time, a specific zooming size of the scene, a specific viewing angel of the scene, a specific searching-keyword, and a combination thereof.

18. The system of claim 11, wherein the specific information is relevant to the subject area, or the specific condition.

19. The system of claim 11, wherein the one or more hyperlinks are generated automatically by determining the relevance between the contents of the parent webpage and the contents of the one or more 1^{st} order webpages.

20. The system of claim 11, wherein the parent webpage provides a 720-degree view of the scene of the subject area including a 360-degree rotational view in the horizontal direction and a 360-degree rotational view in the vertical direction.
